(19) United States
(12) Patent Application Publication
(10) Pub. No.: US 2023/0111408 A1
(43) Pub. Date: Apr. 13, 2023

(54) TECHNIQUES FOR CAPTURING AND RENDERING VIDEOS WITH SIMULATED REALITY SYSTEMS AND FOR CONNECTING SERVICES WITH SERVICE PROVIDERS

(71) Applicant: Immersive Tech, Inc., Tampa, FL (US)

(72) Inventors: John Clagg, Tampa, FL (US); Erik Maltais, Tampa, FL (US)

(21) Appl. No.: 17/890,869

(22) Filed: Aug. 18, 2022

Related U.S. Application Data
(63) Continuation of application No. 16/224,571, filed on Dec. 18, 2018, now abandoned.
(60) Provisional application No. 62/607,254, filed on Dec. 18, 2017.

(51) Int. Cl. H04N 13/194; H04N 13/156; G06T 5/00; G06T 5/50; H04N 13/239; H04N 7/18; H04N 13/344; H04N 13/296

(52) U.S. Cl. CPC H04N 13/194; H04N 13/156; G06T 5/006; G06T 5/50; H04N 13/239; H04N 7/18; H04N 13/344; H04N 13/296; H04N 13/332

(57) ABSTRACT

The disclosed techniques involve simulated reality systems, which can include a head mounted display (HMD) device that can remotely control a three-dimensional (3D) stereoscopic camera rig based on position, motions, and/or orientation data of the HMD device. The system may include multiple video cameras arranged side-by-side on a rig to capture video feeds of a real-world environment that can be stitched together in real-time to create a single stereoscopic 3D, 180 degree video rendered with a HMD as a panoramic video. An example of a use case includes pairing automotive body shops and insurance claims adjusters, and allowing them to perform insurance claim adjustments remotely via a live peer-to-peer video. Further, a process of creating an algorithm that pairs vehicle damages with insurance claim adjusters who have experience with particular vehicle makes and models is disclosed.

### CROSS-REFERENCE TO RELATED APPLICATIONS

The current application claims the benefit of and priority under 35 U.S.C. § 119(e) to U.S. Provisional Patent Application No. 62/607,254 entitled “Techniques for Capturing and Rendering Videos with Simulated Reality Systems and for Connecting Services with Service Providers” filed Dec. 18, 2017. The disclosure of U.S. Provisional Patent Application No. 62/607,254 is hereby incorporated by reference in its entirety for all purposes.

### FIELD OF THE INVENTION

The disclosed teachings relate to capturing and rendering videos in simulated reality systems. The disclosed teachings more particularly relate to controlling and stitching together videos in real-time that are captured by remotely located cameras, and implementations for coupling service providers and services via simulated reality systems.

### BACKGROUND

A simulated reality (e.g., virtual reality (VR), augmented reality (AR)) system may include a head mounted display (HMD) device that has one or more displays capable of rendering content viewable by a user wearing the HMD device. The content can include audio, still images, and/or videos. There are numerous conventional HMD devices available for consumers and user adoption continues to grow even though applications are limited. For example, a typical application includes creating an artificial environment such as rendering a VR gaming environment on an HMD device.

There is an increasing demand to experience real-world environments that are remote to the user of a simulated reality system. In particular, there is an increasing demand from users for video content that can be rendered on simulated reality systems. However, video cameras (e.g., webcams) typically only capture a video feed having a single view that is only viewable on conventional displays. There is also an increasing demand for experiencing real-time fully immersive environments of remote real-world environments. However, no such systems exist.

### SUMMARY OF THE INVENTION

The disclosed embodiments involve techniques for capturing and rendering videos with simulated reality systems. Examples of simulated reality systems include virtual reality (VR), augmented reality (AR), or any mixed reality system. A simulated reality system can include a head mounted display (HMD) device that includes one or more displays that can project images towards the eyes of a user wearing the HMD device. As such, a user wearing an HMD device can have an immersive experience by viewing images in three-dimensions (3D) such as 3D stereoscopic videos.

The disclosed embodiments also enable users to have an immersive experience in real-time (or near real-time) of real-world environments. For example, a user in the Boston could use an HMD device to experience being in Paris in real-time. In some embodiments, the remotely located cameras that capture videos for the HMD device can be controlled with the HMD device. For example, an HMD device can remotely control a camera rig based on its position, motion, and/or orientation under the control of the user wearing the HMD device.

In particular, a 3D stereoscopic camera rig on a gimbal stabilizer can be connected over a computer network to an HMD device that can control the position of a camera based on the position of the HMD device. The camera views can track the views of a user wearing the HMD device to experience a fully immersive view of a real-world environment in real-time that is under the control of the user.

The simulated reality system may include multiple video cameras arranged side-by-side on one or more rig that can capture video images used to create a stereoscopic 3D video feed by stitching together the multiple video feeds that are ultimately rendered by the HMD device. The disclosure includes at least one technique for stitching together multiple camera video feeds in real-time to create a single stereoscopic 3D, 180-degree panoramic video for an HMD device.

The disclosure also includes particular implementations that involve pairing service providers to services over a network that can use the disclosed simulated reality system. For example, an implementation pairs automotive body shops and insurance claims adjusters, allowing them to perform insurance claim adjustments remotely via a live peer-to-peer video feed. Further, a process of creating an algorithm that pairs vehicle damages with insurance claim adjusters who have experience with particular vehicle makes and models is also disclosed.

Systems and methods for transmitting and receiving stereoscopic video in accordance with embodiments of the invention are illustrated. One embodiment includes a method for capturing and transmitting a stream of stereoscopic video. The method includes steps for identifying multiple subgrids for each frame of stereoscopic video and establishing a connection with a set of one or more peer devices. The connection includes multiple channels corresponding to subgrids. For each channel of the plurality of channels, the method further includes steps for determining whether the subgrid is updated, pausing the channel when the subgrid has not been updated, and sending image data for the channel when the subgrid has been updated.

In a further embodiment, a size of each subgrid of the plurality of subgrids is one of 4, 9, 16, 25, 36, 49, and 64 pixels along at least one edge of the subgrid.

In still another embodiment, the method further includes steps for stitching the frame of stereoscopic video from a first image from a first camera and a second image from a second camera.

In a still further embodiment, a lens of the first camera and a lens of the second camera are 60 mm apart.

In yet another embodiment, a lens of the first camera and a lens of the second camera are fisheye lenses.

In a yet further embodiment, the connection is established using a WebRTC protocol.

In another additional embodiment, determining whether the subgrid is updated includes calculating a difference between a current value for each pixel of the subgrid against a cached value for the pixel, and determining whether the calculated differences of the subgrid exceeds a particular threshold.

In a further additional embodiment, pausing the channel includes sending an image composed of black, alpha 0 pixels.

In another embodiment again, sending image data includes calculating a difference between a current value for each pixel of the subgrid against a cached value for the pixel, storing the current value for the pixel in an image when the calculated difference exceeds a threshold, storing a black, alpha 0 value for the pixel in the image when the calculated difference does not exceed the threshold, and sending the image.

Another embodiment includes a method for displaying a stream of stereoscopic video. The method includes a step for establishing a connection with a transmitting device. The connection includes a plurality of channels associated with a plurality of subgrids of each frame of a stream of stereoscopic video. For each channel, the method includes steps for analyzing image data for each subgrid for changes from a cached version of the subgrid, and applying the changes to the cached version of the subgrid. The method further includes steps for recombining the cached versions of the plurality of subgrids into an image, correcting the recombined image, and displaying the corrected image.

In a further embodiment again, each frame includes a set of one or more fisheye images.

In still yet another embodiment, analyzing image data comprises, for each pixel of the subgrid, determining that the pixel has changed if the value of the pixel is not black.

In a still yet further embodiment, correcting the recombined image includes performing a fisheye lens correction.

Additional embodiments and features are set forth in part in the description that follows, and in part will become apparent to those skilled in the art upon examination of the specification or may be learned by the practice of the invention. A further understanding of the nature and advantages of the present invention may be realized by reference to the remaining portions of the specification and the drawings, which forms a part of this disclosure.

### BRIEF DESCRIPTION OF THE DRAWINGS

The description and claims will be more fully understood with reference to the following figures and data graphs, which are presented as exemplary embodiments of the invention and should not be construed as a complete recitation of the scope of the invention.

FIGS. 1A and 1B illustrate an arrangement to create a three-dimensional (3D) stereoscopic view with a virtual reality (VR) head mounted display (HMD) device.

FIG. 2 illustrates a mobile-based and computer-based VR arrangement.

FIG. 3 illustrates a simulated reality system including a computer, cameras, and various other components configured to capture video feeds from remote cameras and render a stereoscopic 3D video with a VR-HMD device.

FIG. 4 illustrates a process for real-time video stitching of videos from multiple cameras.

FIG. 5 illustrates a lens distortion correction technique.

FIG. 6 illustrates a peer-to-peer network for capturing videos and rendering a simulated reality video feed.

FIG. 7 conceptually illustrates a process for transmitting 3D stereoscopic video.

FIG. 8 conceptually illustrates a process for receiving and streaming 3D stereoscopic video.

FIG. 9 illustrates a process performed by a client-side device to render 3D imagery.

FIG. 10 is a high-level block diagram illustrating an example of a computing system in which at least some operations described herein can be implemented.

### DETAILED DESCRIPTION

The embodiments set forth below represent the necessary information to enable those skilled in the art to practice the embodiments and illustrate the best mode of practicing the embodiments. Upon reading the following description, in light of the accompanying Figures, those skilled in the art will understand the concepts of the disclosure and will recognize applications of these concepts that are not particularly addressed herein. It should be understood that these concepts and applications fall within the scope of the disclosure and the accompanying embodiments.

The purpose of the terminology used herein is only for describing embodiments and is not intended to limit the scope of the disclosure. Where context permits, words using the singular or plural form may also include the plural or singular form, respectively.

As used herein, unless specifically stated otherwise, terms such as “processing,” “computing,” “calculating,” “determining,” “displaying,” “generating” or the like, refer to actions and processes of an electronic computing device that manipulates and transforms data, represented as physical (electronic) quantities within the computer's memory or registers, into other data similarly represented as physical quantities within the computer's memory, registers, or other such storage medium, transmission or display devices.

As used herein, the terms “connected,” “coupled,” or variants thereof refer to any connection or coupling, either direct or indirect, between two or more elements. The coupling or connection between the elements can be physical, logical or a combination thereof.

As used herein, the term “real-time” can refer to the actual time during which a process or event occurs. However, the same term can refer to a process that includes a delay (e.g., a latency of 200 milliseconds). As such, “real-time” and “near real-time” are used synonymously. The delay may be central to some use cases such as, for example, a factor considered by the DRs/industry for a specific medical use case.

The disclosed embodiments include a method or process of real-time stitching of dual, side-by-side camera video streams into a single stereoscopic, fully immersive, three-dimensional (3D) video stream. The videos captured by the cameras can be of real-world scenes rather than artificial scenes of computer generated imagery. The embodiments improve over existing techniques that require several hours (e.g., 3-5 hours) of post-production per minute of 3D video stream to create a 3D video stream from multiple video streams. The improvement includes a stitching technique that can perform the task of stitching together of video streams on the fly with 3D-video auto-stitch ing.

The disclosed embodiments also include a method or process of a playback that system and involves rendering of immersive video on display(s) as a stereoscopic 3D, 180-degree panoramic video in a virtual reality (VR) head mounted display (HMD) device. In order to view fully immersive 3D video, the playback system includes a VR player to allow head-tracking as a user views a video through the HMD device.

The disclosed embodiments also include a method or apparatus for remotely manipulating and/or controlling a camera rig via head-tracking data in a simulated reality system. A use case includes a telemedicine application. For example, embodiments include the capability to use head-tracking data from a mobile device (e.g., smartphone) of an HMD device to physically manipulate a gimbal remotely, which allows a user of the HMD device to choose a focal point or viewpoint. For example, the simulated reality system can translate data indicative of the position, motion, and/or orientation (e.g., including rotation, angle) of an HMD device into positioning data transmitted over a computer network to control the position, motion, and/or orientation of the remote camera.

The disclosed embodiments also include a process or system for remotely pairing service providers and services. For example, insurance claim adjusters having specialized experience can be paired with specific adjustment jobs. Embodiments are not limited to simulated reality systems and can instead use a conventional two-dimensional (2D) video camera feed communicated over a computer network. Moreover, service providers are not limited to insurance adjusters or claim adjustments. Instead, embodiments can include pairing of any service to any suitable service provider.

For example, the disclosed embodiments include a process for remotely connecting uniquely qualified medical specialist to medical situations for observation, consultation, or interactivity in real-time, in a fully immersive virtual environment. Other embodiments include a process for remotely connecting a specialist to fully immersive 3D virtual instances for specific observation, consultation, or interactivity.

Overview

An HMD device is capable of rendering 3D stereoscopic content for view by a user wearing the HMD device. As indicated above, HMD device technology is generally available on the market today and adoption is growing. The demand for video content is also growing and can be a medium for playback on an HMD device. Hence, it would be compelling to offer video content consumed by HMD devices such that video captured remotely of real-world scenes can be viewed by a user wearing the HMD device in real-time.

The disclosed technology overcomes the drawbacks of existing technologies that use video webcams that only support capture of a single image video feeds and are not intended to be viewed with HMD devices. In particular, the disclosed technology enables existing cameras (e.g., webcams) to stream stereoscopic 3D video, which is intended to be viewed in HMD devices. For example, the proposed technology can capture image data from two video cameras, two pairs of parallel images at a time, to be used as left and right eye images of an HMD device, corresponding to images to be viewed per eye in the HMD device, to create a 3D stereoscopic image for the viewer.

In some embodiments, a stereoscopic 3D, 180-degree panoramic video is created of a sequence of side-by-side video frames from two angles, at an average interpupillary distance simulating the distance between a user's eyes, which depicts a wide view of a surrounding environment with a 3D perspective giving the visual perception of depth. For example, a webcam (or video camera in general) can be fitted with one or more fisheye lenses to capture a wide, 180-degree field-of-view (FOV) video of a scene that can be rendered by an HMD device. By stitching together the videos of multiple cameras, a 360 degree scene can be rendered by an HMD device.

Limiting the view to only half of a 360-degree scene (180-degrees) results in a higher definition video compared to viewing the 360-degree scene, and makes resorting to methods such as splitting-up a video file into multiple “viewing angle” files unnecessary. A user viewing the 180-degree panoramic video can essentially see the total wide view of an area straight in front of the user, creating the feeling of a virtual “presence.” There are multiple use cases for viewing live (e.g., real-time) stereoscopic 3D, 180-degree wide view video with an HMD device, including but not limited to virtual medical surgical observation and auto insurance adjustment procedures.

### Insurance Claim Adjustment Specialist Selection Algorithm

The disclosed embodiments include a system and process that can use the simulated reality system to link automotive body shops and insurance claim adjusters over a network, to allow the two parties to perform insurance claim adjustments remotely via a live peer-to-peer video. Moreover, the disclosed embodiments include a process of creating an algorithm that pairs vehicle damages with insurance claim adjusters who have experience with particular vehicle makes and/or models. That, in turn, creates a more efficient insurance claim adjustment process by allowing for one regional location with in-house adjusters to service larger areas and does not require excessive transportation from multiple distributed in-house adjusters. In some embodiments, an objective of this process is for a job to get assigned to the insurance claims adjuster with the most suitable experience to handle the claim, which increases the overall efficiency of the insurance adjustment process.

### Remote 3D Camera Rig Controlled Via Simulated Reality System

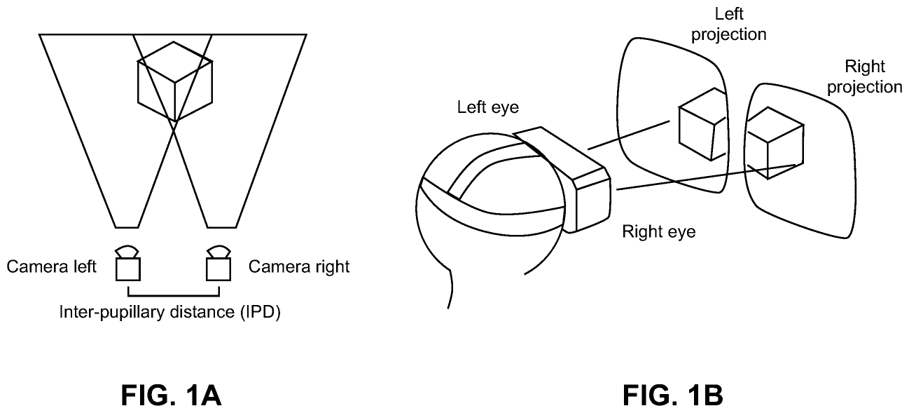

FIGS. 1A and 1B illustrate an arrangement for stereoscopic 3D imagery viewing with an HMD device. In particular, FIG. 1A illustrates a relationship between a left camera and a right camera relative to an interpupillary distance (IPD) of a user. As shown, the right and left cameras capture different angles of the same object. FIG. 1B illustrates a user wearing an HMD device, which projects a left projection and a right projection of the same object in FIG. 1A to render a stereoscopic 3D image.

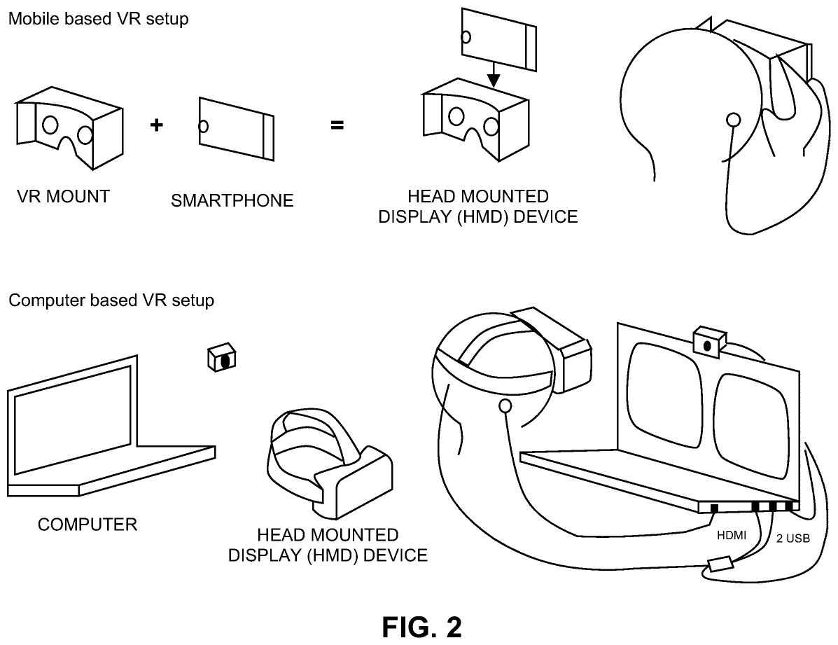

There are different arrangements of simulated reality systems. For example, FIG. 2 illustrates a mobile-based VR setup and a computer-based VR setup. The mobile-based VR setup includes a VR mount that can receive a smartphone to collectively form an HMD device. The HMD device can be positioned relative to the user's eyes so that the user can have an immersive experience. The sensors of the smartphone can be used to track the position of the user's head.

In another example, the computer-based VR setup includes a computer coupled to an optional camera and/or position detector, which are collectively coupled to an HMD device. As shown, the computer can transmit image data to the HMD device while capturing positioning data of the user wearing the HMD device so that images rendered by the HMD device can track a position, motion, and/or orientation of the user's head.

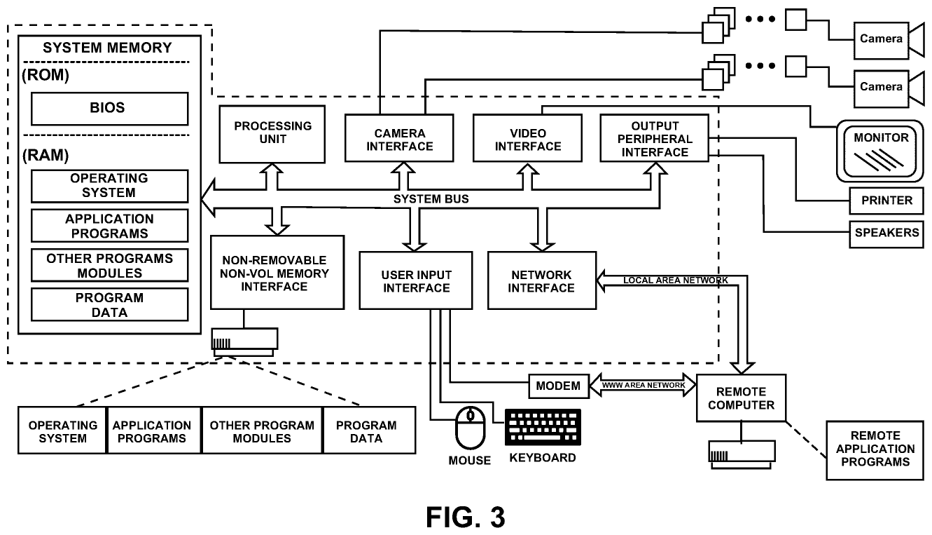

The disclosed embodiments include a system to allow a user wearing an HMD device to remotely control a camera on a camera rig via head position, motion, and/or orientation data obtained of the HMD. In some embodiments, a 3D stereoscopic camera rig on a gimbal stabilizer is setup at a remote area and connected to a wide-area network (e.g., Internet). A user wearing an HMD device can view the remote 3D live footage and control the angle and direction that the camera is facing via HMD device data of its position, motion, and/or orientation used to produce control data. The control data of the user's HMD device can be gathered by collecting fusion sensor data of the HMD device's sensors (e.g., accelerometers, gyroscopes, magnetometers). As such, a remote camera can track wherever the user faces, sending the corresponding surrounding area view to the user in order to create an immersive VR view. In some embodiments, the 3D camera arrangement includes two video cameras in a side-by-side rig to collect video streams used to create a stereoscopic 3D video feed by stitching the two video camera feeds into a single stitched video feed. For example, FIG. 3 illustrates simulated reality system including a computer, cameras, and various components configured to capture multiple video feeds and render a stereoscopic 3D video for a user viewing it with a VR-HMD device.

Real-Time Stitching of Multiple Webcams into a Single Stereoscopic 3D Video Stream

The disclosed embodiments include a system or process for stitching two video camera feeds together in real-time to create a single stereoscopic 3D, 180 degree video for viewing as a panoramic video with an HMD device. In some embodiments, the video is rendered with but not limited to an internet web browser on the display(s) of an HMD device. Hence, a stitching process for multiple camera video feeds can create a single stereoscopic 3D video. The disclosed technology also includes a method for network streaming and a method to render the video feed as a 180-degree panoramic video with an HMD device.

In addition to rendering video with an HMD device, the disclosed embodiments include a method that allows a user to control which portion of a scene depicted by the 3D panoramic video is viewed, as well as a graphical user interface (GUI) that allow a user to select which video is to be rendered when there are multiple videos to choose from, and can also include 3D controls that allow video playback functions such as choosing when to play or pause a selected video.

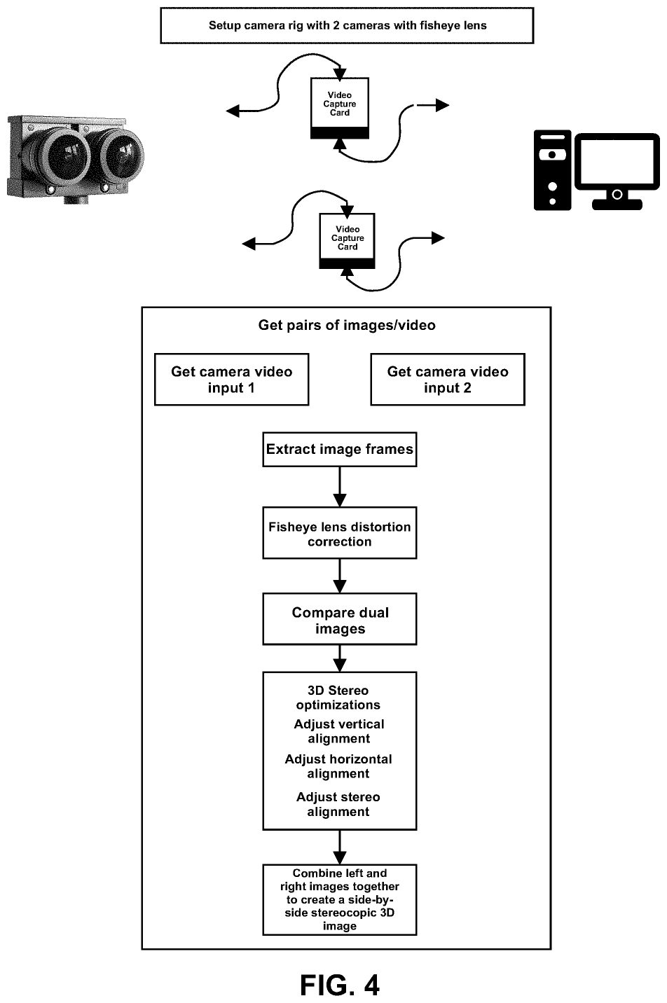

FIG. 4 illustrates a process for real-time video stitching of videos from multiple cameras. As shown, the camera arrangement includes a camera rig with two cameras each having one or more fisheye lenses. The cameras are connected to a computer via one or more video camera cards. The computer obtains pairs of images and processes them to stitch into a single feed.

For example, the computer can obtain two inputs of different camera video feeds. Next, the image frames are extracted from the two camera video inputs. The computer can then perform a fisheye lens distortion correction process. Dual images from the camera videos are compared. The computer then performs 3D stereo optimizations including performing any of vertical alignment adjustment, horizontal alignment adjustment, or stereo alignment adjustment. Lastly, the computer combines the left and right images together to create a side-by-side stereoscopic 3D image.

More specifically, a single 180-degree stereoscopic 3D video is generated by capturing image data from multiple cameras and “stitching” the image frames together, at a selected video frames-per-second (FPS) to create the single stereoscopic 3D video with the combined image frames. To accomplish a wide angle perspective, 180-degree fisheye lenses are installed on the cameras. Many cameras allow custom lenses to be installed, whereas other cameras need minor modifications made to the case of the camera to allow for changing of the lens to fisheye lenses.

As shown, the video cameras are connected directly to a computer via USB or can be plugged into graphic capture cards, which are connected to the computer. In some embodiments, camera drivers are required to be installed and active. Video input is captured in parallel via capture cards at a relatively high FPS from the multiple cameras. Single Image frames are extracted from each video feed and processed. The individual image frames, which are distorted due to the fisheye lens attachments, are then processed with a lens distortion correction process such as de-warping.

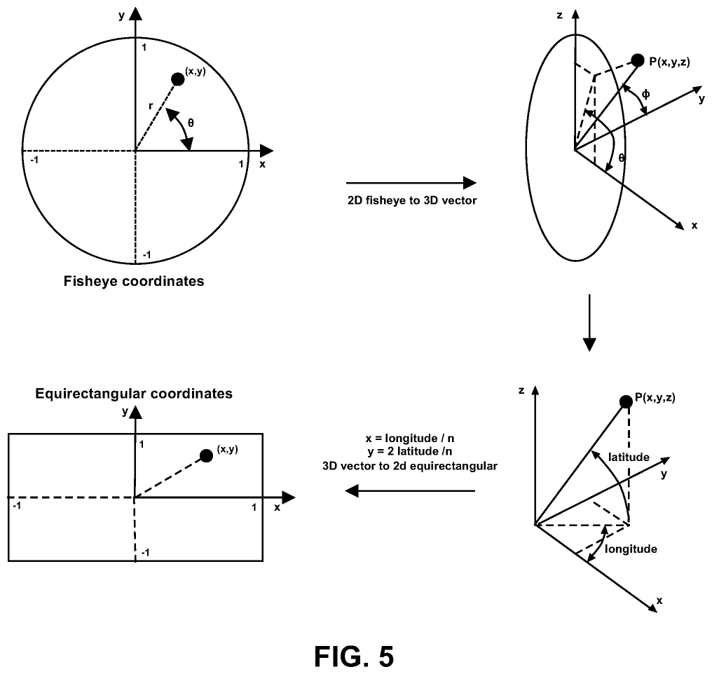

FIG. 5 illustrates a lens distortion correction technique. When 180-degree wide-angle lenses are installed on the cameras, the lenses produce a pronounced barrel distortion. Lens distortion is corrected by applying algorithmic transformations to each image frame. In this case, fisheye projections are converted into spherical equirectangular projections, appropriate to use as a mesh texture for a 3D sphere object. The process of the image transformation is to perform inverse mapping. Each pixel in the output image is considered and mapped backwards to find the closest pixel in the input image. In this way, every pixel in an output image is found compared to a forward mapping, it also means that the performance is governed by the resolution of the output image (and super-sampling) irrespective of the size of the input image.

Referring back to FIG. 4, antialiasing is performed using a super-sampling method, where each pixel of the output image is sampled multiple times at different subpixel positions. The best estimates from the input images can be averaged together. The images corresponding to the left and right camera feeds are compared, and 3D stereoscopic optimizations are applied, including vertical and horizontal adjustments and stereoscopic convergence to create a 3D image with optimal depth perception. Image calibration and image resizing (e.g., to a power of 2) for optimal 3D mesh texturing is then performed. The generated side-by-side 3D panoramic video is then prepared to be sent over the network to another peer over the network (e.g., local or wide-area network).

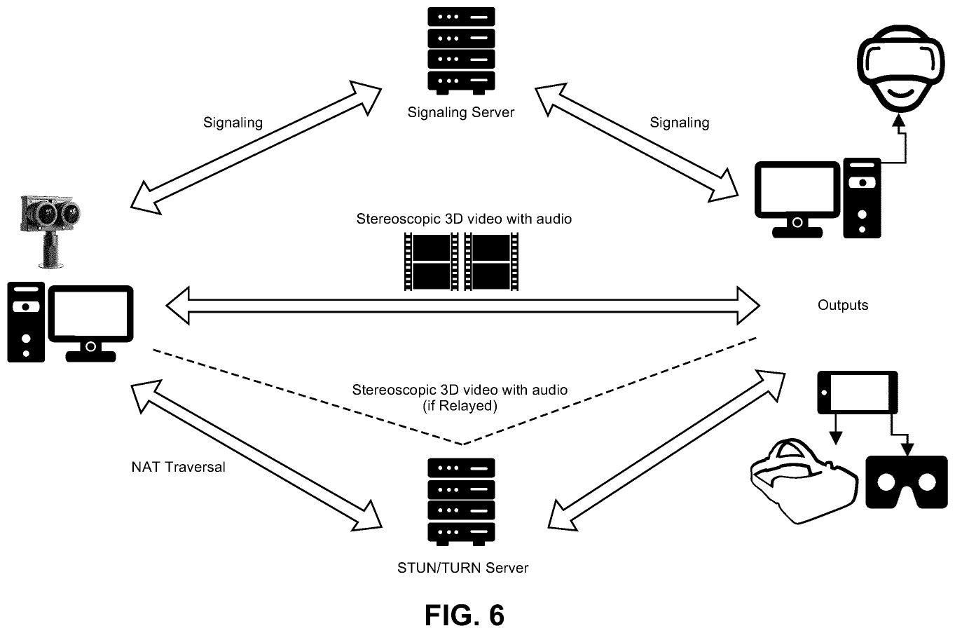

The video is streamed in real-time to another remote user by, for example, using peer-to-peer (P2P) technology (e.g., WebRTC) to maintain network latency at a minimum. For example, FIG. 6 illustrates a peer-to-peer network. When using a WebRTC P2P system, Peer A, the user outputting the 3D stereoscopic video, will initiate a connection by creating a communication offer and sending this offer to Peer B via a network signaling channel. Peer B then receives the P2P communication offer from the network signaling channel and creates a communication answer that is sent back to Peer A via the network signaling channel.

A session description includes information about the kind of media being sent, its format, the transfer protocol being used, the endpoint's IP address and port, and other information needed to describe a media transfer endpoint. This information is then exchanged and stored using session description protocol (SDP).

When a user starts a WebRTC call to another user, a special description is created called an offer. This description includes all the information about the caller's proposed configuration for the call. The recipient then responds with an answer, which is a description of their end of the call. In this way, both devices share with one another the information needed in order to exchange media data. This exchange can be handled using interactive connectivity establishment (ICE), a protocol which lets two devices use an intermediary to exchange offers and answers even if the two devices are separated by network address translation. Then, each peer keeps two descriptions on hand: the local description describing itself, and the remote description describing the other end of the call. The offer/answer process can be performed both when a call is first established and also any time the call's format or other configuration needs to change.

Systems and methods for real-time capturing and streaming techniques of high-resolution stereoscopic video with low latency are described below. In some embodiments, a transmitting system includes an array of cameras connected to a computer. Array cameras in accordance with many embodiments of the invention can be connected to the computer in a variety of ways including (but not limited to) through video capture cards, through direct connections, etc. In a variety of embodiments, the computers can retrieve image (video) data from HDMI feeds of the array of cameras. In many embodiments, camera arrays are configured in such a way that the lens separation is approximately 60 mm. This is done so that the images produced will match the average human interpupillary distance and create a stereoscopic image when looked at simultaneously with each rendered image paired with the corresponding eye. In a variety of embodiments, processes can stitch captured image frames together into a single side-by-side stereoscopic frame which is ready for processing. In various embodiments, image frames are divided into subgrids (4, 9, 16, 25, 36, 49, 64 units) that can be analyzed separately for a transmission process.

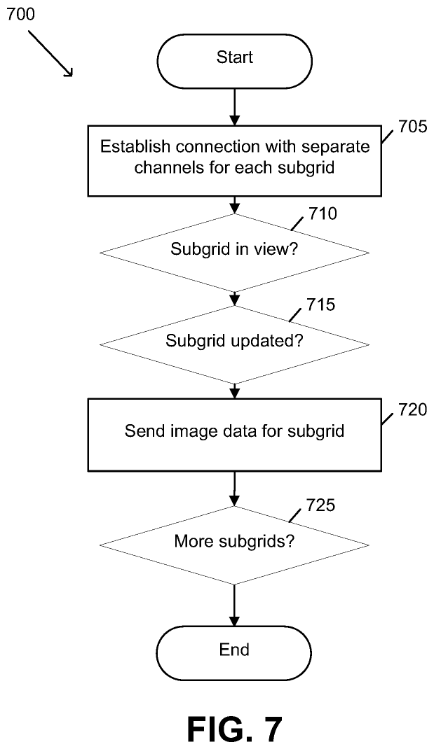

A process for transmitting video in accordance with an embodiment of the invention is illustrated in FIG. 7. In some embodiments, a network is established, over the internet, and a connection is made with a set of one or more remote peers which will receive the collected channels of video subgrids and an audio stream. Multiple channels are opened in the connection depending on the number of subgrids being sent. Each subgrid in the frame corresponds to an open channel in the connection. Establishing connections between devices can be performed in a number of different ways in accordance with certain embodiments of the invention. In several embodiments, a transmitting device establishes a secure connection with a set of one or more viewing devices. Connections in accordance with numerous embodiments of the invention establish multiple channels, where a channel is associated with each subgrid.

Process 700 determines (710) whether a subgrid is in a viewing area. In a variety of embodiments, captured video streams can include fisheye images, where significant portions of the image are always black. In some such embodiments, no channel is established for these subgrids, while in other embodiments a channel is established, but is paused to minimize network traffic. When the process determines (710) that a subgrid is not in the viewing area, the process 700 proceeds to step 725. In a number of embodiments, processes can pause a channel prior to proceeding. Pausing a channel can include (but is not limited to) providing a pure black image, providing an where each pixel has an alpha value of 0, etc. In several embodiments, when a subgrid-channel is paused, all bandwidth requirement related to that channel ceases completely, no data packets are sent.

When the process determines (710) that a subgrid is at least partially within the viewing area, the process 700 determines (715) whether the subgrid has been updated from a previous instance in time (e.g., from a previous frame). To measure the level of change, processes in accordance with several embodiments of the invention can sample and compare the corresponding current and previous subgrids for each image frame to check for substantial changes. In some embodiments, substantial changes are determined based on whether a change score for the subgrid exceeds a threshold value. Changes in accordance with several embodiments of the invention can be measured based on one or more of a variety of different values including (but not limited to) average pixel value changes, detected movement, and/or perceptual changes based on a person's ability to perceive visual changes. Noticeable changes in the frame in accordance with several embodiments of the invention can include (but are not limited to) movement of existing subjects or the entrance of something into the scene.

When the process determines (715) that the subgrid has not changed, the process 700 proceeds to step 725. In certain embodiments, for subgrids that have not changed significantly, a single command is sent to the receiver telling it to pause that part of the frame, disabling the subgrid channel until changes occur. When the process determines (715) that the subgrid has changed, the process 700 sends (720) image data for the subgrid through the associated channel to a receiver device. In certain embodiments, sending the image data can include marking the channel for the subgrid as “live” and allowing the streaming of the subgrid to continue. In numerous embodiments, for the subgrids that are still marked as “live”, further processes are performed to find only the portions of the image that have changed. Processes in accordance with certain embodiments of the invention set all the pixels that have not changed from the preceding frame to black with an alpha of 0, so that these image portions are flagged to not display on the receiving end. This leads to as increase in the compressibility of the entire subgrid, even when it has changed. By only sending the changes between frames, processes in accordance with various embodiments of the invention allow for an overall increase in the total available bandwidth, which allows for greater image quality and lower latency.

Process 700 then determines (725) whether there are other subgrids to analyze. When there are more subgrids, the process returns to step 710 for the next subgrid. When there are no more subgrids, the process ends. In several embodiments, the process is performed continuously as long as a stream continues or as long as a peer device is connected to a stream.

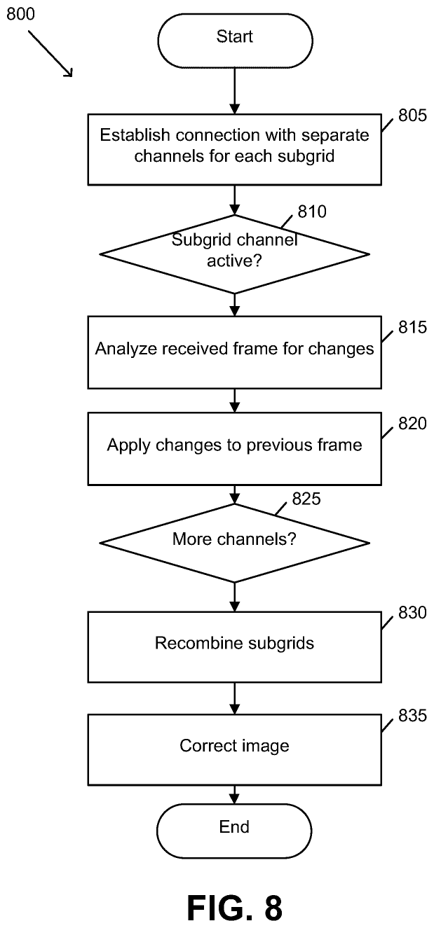

A process for streaming high-resolution stereoscopic video is conceptually illustrated in FIG. 8. Process 800 establishes (805) a connection with a streaming device to receive a stream. The received stream in accordance with numerous embodiments of the invention is a live stream captured by an array of cameras. In a number of embodiments, in order to render the stereoscopic 3D video, a receiving device (or peer) receives video streams for each channel/subgrid.

Process 800 determines (810) whether a channel for a subgrid is active. In certain embodiments, processes can determine that a channel is active based on a status of the channel that is managed out of band. Processes in accordance with certain embodiments of the invention can determine that a channel is active based on what is received over the channel. For example, in some embodiments, processes can determine a channel is inactive (or paused) when the received content is purely black and/or filled with 0 alpha-values. When a channel for a subgrid is not active, process 800 proceeds to step 825. When the process determines that the channel is active, process 800 analyzes (815) the received frame. In some embodiments, processes can analyze the received frame using a pixel-by-pixel analysis, identifying changes for any pixel that is changed (e.g., a pixel that is not black with alpha value 0). Process 800 applies (820) identified changes from the new frame to a previously stored frame at the peer device. Process 800 then determines (825) whether there are more subgrid channels to analyze. When there are more subgrid channels, process 800 returns to step 810 for the next subgrid channel. When all the subgrid channels for a frame have been analyzed, process 800 recombines (830) the received subgrid frames from the subgrid channels. In many embodiments, processes compose all of the image frames from the subgrid-channels into a single image texture. For subgrid-channels that are marked as being “paused”, processes in accordance with a number of embodiments of the invention reuse the preceding image-frame for that channel from cache. For subgrid-channels that are marked as being “active”, processes in accordance with a variety of embodiments of the invention update only the pixels that have changed on the texture and are not black-alpha-0. In various embodiments, the texture viewport is not cleared between updates but rather written over with only the pixel changes.

Process 800 corrects (835) the combined image and the process ends. In several embodiments, the transmitted image and/or the stored frame at the peer device are uncorrected fisheye (or wide-angle) images. Processes in accordance with many embodiments of the invention apply fisheye lens correction algorithms to produce each side-by-side equirectangular image frame so that the frame is perceived as natural when viewed in a virtual reality head-mounted-display. In a number of embodiments, a three-dimensional mesh is created within the scene and the texture is applied to the mesh. In some embodiments, only one half of the total side-by-side texture is applied to the mesh, per eye, to save on rendering time.

Fisheye images in accordance with numerous embodiments of the invention are all black around the circumference of the fisheye circle, allowing for more total black pixels in the image frame when being sent with fisheye distortions. Processes in accordance with certain embodiments of the invention encode the sequences of black pixels. In numerous embodiments, in order to further reduce the total bandwidth requirement, agreements are made between the transmitting and receiving sides on which pixels are black and those pixels are never sent. With less information being sent, by doing the fisheye lens correction on the receiving side rather than the transmission side, there is further bandwidth saving and latency reduction.

The corrected image can then be displayed to a user (e.g., through a virtual reality head-mounted display). In numerous embodiments, a graphics library is used (e.g. OpenGL) to create two separate scenes, one for each eye in the virtual reality head-mounted-display. In a variety of embodiments, because the capture camera lens separation for the camera array was set to the average interpupillary distance, the two separate scenes are rendered with all their objects set at an appropriate distance from each other to the perspective of each eye. This creates the stereoscopic 3D effect in the head-mounted-display.

As can readily be appreciated the methods used to capture and stream stereoscopic images are largely dependent upon the requirements of a given application. One skilled in the art will recognize that steps can be omitted and/or reordered without departing from the scope of the invention, and should not be considered as limited to any specific implementation.

### Playback to Render Stereoscopic 3D, 180-Degree Panoramic Videos in a VR-HMD

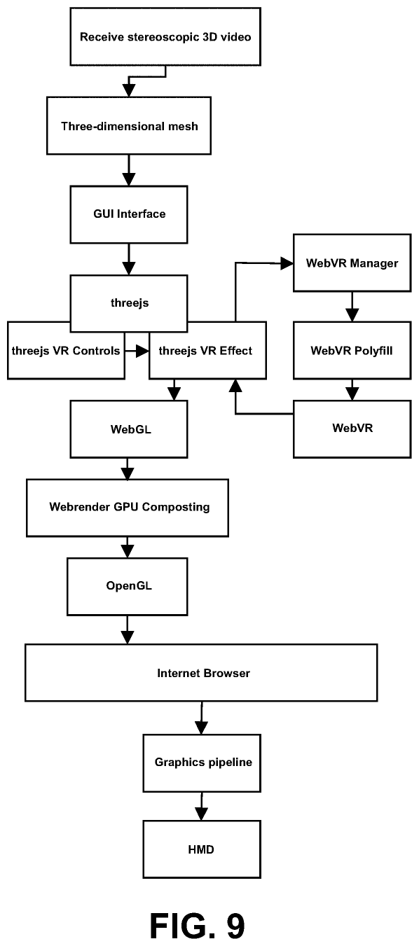

The disclosed embodiments include a method for playback of a stereoscopic 3D, 180-degree panoramic video by using a graphical user interface (GUI). For example, FIG. 9 illustrates a process performed by a client-side device to render 3D imagery. As shown, the method includes receiving a stereoscopic 3D, 180-degree panoramic video, creating a 3D mesh, and attaching the video to a texture rendered onto a 3D mesh to be viewed with an HMD device.

In some embodiments, an overlaid GUI displays a time selection interface and allows selecting a frame time in the video with the time selection interface. The GUI displays a view selection interface and view parameters that define camera orientation at the frame time of the stereoscopic panoramic video. The VR system displays the 3D video mesh onto the HMD device, receives user input for moving a location of the virtual cursor in virtual space, and receives user input for selecting control functions based on 3D collision logic.

The incoming video data may be provided via real-time streaming or previously recorded over a (directly P2P) network from a server, or it may simply be read from a storage media such as a DVD or hard drive. The 3D rendering process involves 3D texture mapping that uses image frame data and maps textures onto a spherical 3D model. This can be performed using computer graphics methods.

The output of the 3D rendering is provided to a HMD device, and the 3D panoramic video is viewed by a user of the system wearing the HMD device. The user will be viewing just a portion of the scene depicted in the panoramic video at any point in time, and will be able to control what portion is viewed by changing the orientation of the HMD device. As such, the panoramic video viewer allows the user to pan through a scene to the left, right, up or down.

In some embodiments, the graphics pipeline creates a 3D scene made of geometric primitives by drawing them as triangles. The pipeline transforms local coordinates to 3D-world coordinate. The object model is placed in the 3D world coordinate system. Then the graphics pipeline transforms the 3D-world coordinate system into a 3D camera coordinate system. The graphics pipeline then performs projection transformation to transform the 3D-world coordinates into a 2D view of a 2D camera.

Geometric primitives that now fall completely outside of a viewing frustum may or will not be visible within the viewport and can be discarded. Rasterization is then performed, which is the process by which the 2D image space representation of the scene is converted into a raster format and the correct resulting pixel values are determined. The graphics pipeline then assigns to individual fragments a color based on values interpolated from the vertices during rasterization, from a texture in memory, or from a shader program. A shader program calculates appropriate levels of color within an image, produce special effects, and perform video post-processing.

When a 3D stereoscopic image frame is mapped over the 3D mesh, the graphics pipeline can interpolate between vertexes of the mesh. Each vertex can be represented as a 3D coordinate of X, Y, and Z parameters.

### Computing System

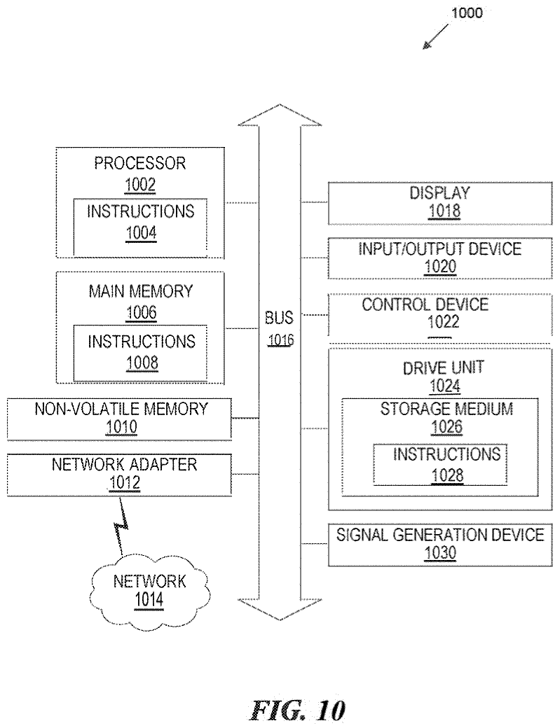

FIG. 10 is a block diagram illustrating an example of a computing system 1000 (e.g., a user device, camera, HMD, or any computing device or system) in which at least some operations described herein can be implemented. The computing system 1000 may include one or more central processing units (e.g., processors 1002), main memory 1006, non-volatile memory devices 1010, network adapter 1012 (e.g., network interface), display 1018, input/output devices 1020, control device 1022 (e.g., keyboard and pointing devices), drive unit 1024 including a storage medium 1026, and signal generation device 1030 that are communicatively connected to a bus 1016.

The bus 1016 is illustrated as an abstraction that represents any one or more separate physical buses, point-to-point connections, or both connected by appropriate bridges, adapters, or controllers. The bus 1016, therefore, can include, for example, a system bus, a peripheral component interconnect (PCI) bus or PCI-Express bus, a HyperTransport or industry standard architecture (ISA) bus, a small computer system interface (SCSI) bus, a universal serial bus (USB), IIC (12C) bus, or an Institute of Electrical and Electronics Engineers (IEEE) standard 2394 bus, also called “Firewire.” A bus may also be responsible for relaying data packets (e.g., via full or half duplex wires) between components of a network device, such as a switching engine, network port(s), tool port(s), etc.

In some embodiments, the computing system 1000 operates as a standalone device, although the computing system 1000 may be connected (e.g., wired or wirelessly) to other machines. For example, the computing system 1000 may include a terminal that is coupled directly to a network device. As another example, the computing system 1000 may be wirelessly coupled to the network device.

In various embodiments, the computing system 1000 may be a server computer, a client computer, a personal computer (PC), a user device, a tablet PC, a laptop computer, a personal digital assistant (PDA), a cellular telephone, an iPhone, an iPad, a Blackberry, a processor, a telephone, a web appliance, a network router, switch or bridge, a(handheld) console, a gaming device, a music player, any portable, mobile, hand-held device, or any machine capable of executing a set of instructions (sequential or otherwise) that specify actions to be taken by the computing system.

While the main memory 1006, non-volatile memory device 1010, and storage medium 1026 (also called a “machine-readable medium) are shown to be a single medium, the term “machine-readable medium” and “storage medium” should be taken to include a single medium or multiple media (e.g., a centralized or distributed database, and/or associated caches and servers) that store one or more sets of instructions 1028. The term “machine-readable medium” and “storage medium” shall also be taken to include any medium that is capable of storing, encoding, or carrying a set of instructions for execution by the computing system and that cause the computing system to perform any one or more of the methodologies of the presently disclosed embodiments.

In general, the routines executed to implement the embodiments of the disclosure, may be implemented as part of an operating system or a specific application, component, program, object, module, or sequence of instructions referred to as “computer programs.” The computer programs typically comprise one or more instructions (e.g., instructions 1004, 1008, 1028) set at various times in various memory and storage devices in a computer, and that, when read and executed by one or more processing units or processors 1002, cause the computing system 1000 to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Further examples of machine-readable storage media, machine-readable media, or computer-readable (storage) media include recordable type media such as volatile and non-volatile memory devices 1010, floppy and other removable disks, hard disk drives, optical disks (e.g., compact disk read-only memory (CD-ROM), digital versatile disks (DVDs)), and transmission type media such as digital and analog communication links.

The network adapter 1012 enables the computing system 1000 to mediate data in a network 1014 with an entity that is external to the computing system 1000, such as a network device, through any known and/or convenient communications protocol supported by the computing system 1000 and the external entity. The network adapter

1012 can include one or more of a network adaptor card, a wireless network interface card, a router, an access point, a wireless router, a switch, a multilayer switch, a protocol converter, a gateway, a bridge, bridge router, a hub, a digital media receiver, and/or a repeater.

The network adapter 1012 can include a firewall which can, in some embodiments, govern and/or manage permission to access/proxy data in a computer network, and track varying levels of trust between different machines and/or applications. The firewall can be any number of modules having any combination of hardware and/or software components able to enforce a predetermined set of access rights between a particular set of machines and applications, machines and machines, and/or applications and applications, for example, to regulate the flow of traffic and resource sharing between these varying entities. The firewall may additionally manage and/or have access to an access control list which details permissions including for example, the access and operation rights of an object by an individual, a machine, and/or an application, and the circumstances under which the permission rights stand.

Other network security functions can be performed or included in the functions of the firewall, including intrusion prevention, intrusion detection, next-generation firewall, personal firewall, etc.

As indicated above, the techniques introduced here can be implemented by, for example, programmable circuitry (e.g., one or more microprocessors), programmed with software and/or firmware, entirely in special-purpose hardwired (i.e., nonprogrammable) circuitry, or in a combination of such forms. Special-purpose circuitry can be in the form of, for example, one or more application-specific integrated circuits (ASICs), programmable logic devices (PLDs), field-programmable gate arrays (FPGAs), etc.

Note that any of the embodiments described above can be combined with another embodiment, except to the extent that it may be stated otherwise above or to the extent that any such embodiments might be mutually exclusive in function and/or structure.

Although specific methods of capturing and rendering 3D video are discussed above, many different methods can be implemented in accordance with many different embodiments of the invention. It is therefore to be understood that the present invention may be practiced in ways other than specifically described, without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A method for capturing and transmitting a stream of stereoscopic video, the method comprising:
identifying a plurality of subgrids for each frame of stereoscopic video;
establishing a connection with a set of one or more peer devices, wherein the connection comprises a plurality of channels corresponding to the plurality of subgrids;
for each channel of the plurality of channels:
determining whether the subgrid is updated;
pausing the channel when the subgrid has not been updated; and
sending image data for the channel when the subgrid has been updated.
